(19) United States
(12) Patent Application Publication
(10) Pub. No.: US 2026/0303502 A1
(43) Pub. Date: Oct. 1, 2026

(54) MULTILINK CONNECTION FOR WIRELESS LOCAL AREA NETWORK DEVICES

(71) Applicant: Synaptics Incorporated, San Jose, CA (US)

(72) Inventors: Patil Sandhya, Bangalore (IN); Girish Anantrao Madpuwar, Bangalore (IN); Saishankar Nandagopalan, San Diego, CA (US); Mohan Ramasudha Karnam, San Jose, CA (US)

(73) Assignee: Synaptics Incorporated, San Jose, CA (US)

(21) Appl. No.: 19/090,116

(22) Filed: Mar. 25, 2025

(51) Int. Cl. H04L 43/0894; H04L 47/62

(52) U.S. Cl. CPC H04L 43/0894; H04L 47/6215

(57) ABSTRACT

Methods and apparatus for multilink wireless communication are disclosed. An example method is performed by a wireless communication system including a first wireless communication core and a second wireless communication core and includes identifying a plurality of packets for transmission via at least one of a first wireless transmitter associated with the first wireless communication core and a second wireless transmitter associated with the second wireless communication core, the first wireless communication core and the second wireless communication core coupled via a coexistence interface, selecting a first portion of the plurality of packets for transmission via the first wireless transmitter and a second portion of the plurality of packets for transmission via the second wireless transmitter, and transmitting the first portion of the plurality of packets via the first wireless transmitter and the second portion of the plurality of packets via the second wireless transmitter.

### TECHNICAL FIELD

The present implementations relate generally to wireless communications, and more specifically to multilink wireless communications.

### BACKGROUND OF RELATED ART

Reliable, deterministic, and predictable-latency data delivery is an important consideration in a variety of contexts, such as in automotive applications. Recent developments in wireless communications standards provide multi-link (ML) protocols so that a station(STA) may connect with an access point (AP) over more than one link, such that frames of data may be transmitted over whichever of the links is able to acquire access to the wireless medium first. One example of such a standard is the Institute of Electrical and Electronics Engineers (IEEE) 802.11be protocol, which may also be called Extremely High Throughput, or EHT.

While EHT, and other protocols which enable ML, may provide significant benefits, they may also be quite complex, having substantial hardware and processing requirements, in addition to requiring significant isolation at the physical layer (PHY) between the links.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure provide methods and apparatus for multilink wireless communications. One innovative aspect of the present disclosure can be implemented as a method for multilink wireless communication performed by a wireless communication system including a first wireless communication core and a second wireless communication core. An example method may include identifying a plurality of packets for transmission via at least one of a first wireless transmitter associated with the first wireless communication core and a second wireless transmitter associated with the second wireless communication core, the first wireless communication core and the second wireless communication core coupled via a coexistence interface, selecting a first portion of the plurality of packets for transmission via the first wireless transmitter and a second portion of the plurality of packets for transmission via the second wireless transmitter, and transmitting the first portion of the plurality of packets via the first wireless transmitter and the second portion of the plurality of packets via the second wireless transmitter.

In some aspects, the first portion of the plurality of packets includes one or more first queues of packets and the second portion of the plurality of packets includes one or more second queues of packets. In some aspects, at least one common queue of the one or more first queues of packets is duplicated within the one or more second queues of packets. In some aspects, selecting the second portion of the plurality of packets for transmission via the second wireless transmitter includes masking visibility of the at least one common queue from a firmware layer of the second wireless communication core, wherein masking visibility of the at least one common queue prevents transmission of the at least one common queue from the second wireless communication core.

In some aspects, the plurality of packets comprises a shared queue of packets for transmission during a specified window of time via either the first wireless transmitter or the second wireless transmitter. In some aspects, selecting the first portion and the second portion further includes selecting a first block of one or more packets of the shared queue for transmission via the first wireless transmitter and selecting a second block of one or more packets of the shared queue for transmission via the second wireless transmitter. In some aspects, the operation 800 further includes designating the first wireless transmitter as a preferred link, wherein the first block includes an initial packet of the shared queue of packets, and the second block immediately proceeds the first block of packets. In some aspects, a number of packets in the first block of packets is selected based at least in part on a first affinity associated with the first wireless transmitter, the first affinity indicating a number of contiguous packets in the shared queue of packets the first wireless transmitter is to transmit during the specified window of time. In some aspects, a number of packets in the second block is selected based at least in part on a second affinity associated with the second wireless transmitter, the second affinity indicating a number of contiguous packets in the shared queue of packets the second wireless transmitter is to transmit during the specified window of time.

In some aspects, the method further includes the first wireless transmitter determining, via the coexistence interface, a window transmission state associated with the first block of packets. In some aspects, the window transmission state associated with the first block of packets indicates that the first wireless transmitter cannot transmit one or more remaining packets of the first block of packets within the specified window of time. In some aspects, the method further includes transmitting, via the coexistence interface, a yield request requesting that the second wireless communication core complete transmission of the one or more remaining packets of the first block of packets. In some aspects, the method further includes receiving, at the first wireless communication core a yield response responding to the yield request, the yield response indicating a transmission status associated with the one or more remaining packets.

Another innovative aspect of the present disclosure can be implemented as a system for multilink wireless communication. An example system includes a first wireless communication core including a first wireless transmitter, a second wireless communication core including a second wireless transmitter, and a coexistence interface coupling the first wireless communication core and the second wireless communication core. The system is configured to identify a plurality of packets for transmission via at least one of the first wireless transmitter and the second wireless transmitter, select a first portion of the plurality of packets for transmission via the first wireless transmitter and a second portion of the plurality of packets for transmission via the second wireless transmitter, and transmitting the first portion of the plurality of packets via the first wireless transmitter and the second portion of the plurality of packets via the second wireless transmitter.

Another innovative aspect of the present disclosure can be implemented as a non-transitory computer-readable storage medium storing instructions for execution by one or more processors of a system for multilink wireless communication. Execution of the instructions causes the system to perform operations including identifying a plurality of packets for transmission via at least one of a first wireless transmitter associated with the first wireless communication core and a second wireless transmitter associated with the second wireless communication core, the first wireless communication core and the second wireless communication core coupled via a coexistence interface, selecting a first portion of the plurality of packets for transmission via the first wireless transmitter and a second portion of the plurality of packets for transmission via the second wireless transmitter, and transmitting the first portion of the plurality of packets via the first wireless transmitter and the second portion of the plurality of packets via the second wireless transmitter.

### BRIEF DESCRIPTION OF THE DRAWINGS

The present embodiments are illustrated by way of example and are not intended to be limited by the figures of the accompanying drawings.

FIG. 1 shows an example system for ML communication, according to some implementations.

FIG. 2 shows an example architecture showing one implementation of the system of FIG. 1, in accordance with some implementations.

FIG. 3 shows an example queue flow using the architecture of FIG. 2, in accordance with some implementations.

FIG. 4 shows an example queue flow using the architecture of FIG. 2, in accordance with some implementations.

FIG. 5A shows an example data structure for a queue and transmission state record, in accordance with some implementations.

FIG. 5B shows a data structure depicting a structure for a simplified link status field, in accordance with some implementations.

FIG. 6A shows a data structure which may be one example of a data structure that the first core may use for requesting that the second core transmit one or more packets initially assigned to the first core (or vice versa), in accordance with some implementations.

FIG. 6B shows an example data structure for a yield response, in accordance with some implementations.

FIG. 7 shows a block diagram of an example coexistence core, according to some implementations.

FIG. 8 shows an illustrative flowchart depicting an example operation for multilink wireless communication, in accordance with some implementations.

FIG. 9 shows an illustrative flowchart depicting an example operation for multilink wireless communication, in accordance with some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory, and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits, and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, recent updates to wireless communications protocols, such as the IEEE 802.11be protocol (“EHT”), enable multi-link (ML) communications. Such protocols may enable a station (STA) to communicate with an access point (AP) via more than one link, such that a frame of data to be communicated from the STA to the AP over the link which acquires access to the wireless medium first. However, such protocols may have substantial hardware and processing requirements. In addition, other channel isolation requirements must be met for such protocols, such as ML EHT requiring significant isolation between the links for communications over the 5 GHz and 6 GHz frequency bands. Consequently, there are many wireless devices which are not capable of reaping the benefits of such recent protocols because they cannot meet such requirements. For example, in some use cases, ML may be desired for primarily latency related purposes rather than for data throughput, which may relax requirements. Some devices which are not capable of implementing EHT or other recent protocols may be called legacy devices, or pre-EHT devices. Therefore, it would be desirable to enable simplified techniques for enabling ML communications for legacy or pre-EHT devices.

Various aspects relate generally to the use of two pre-EHT wireless transceivers, such as a single system on chip (SoC) or similar device including two cores, to implement simplified ML transmission and reception of packets. More specifically, each core may operate independently, where an ML interface and a coexistence interface enable the independent cores to implement ML transmission and reception in accordance with the present disclosure. These and more aspects of the present disclosure are described in more detail below.

Particular implementations of the subject matter described in this disclosure can be implemented to realize one or more of the following potential advantages. By enabling ML transmission and reception to be performed by pre-EHT devices, such devices may be capable of achieving the benefits, particularly in latency, which they would otherwise be incapable of, due to being unable to satisfy the requirements of EHT or other modern ML protocols. Further, due to pre-EHT devices being widely available, aspects of the present disclosure can enable the implementation of ML transmission and reception without requiring the use of additional hardware. For example, aspects of the present disclosure may be implemented using conventional Wi-Fi hardware, requiring primarily alterations to software rather than substantial hardware alterations.

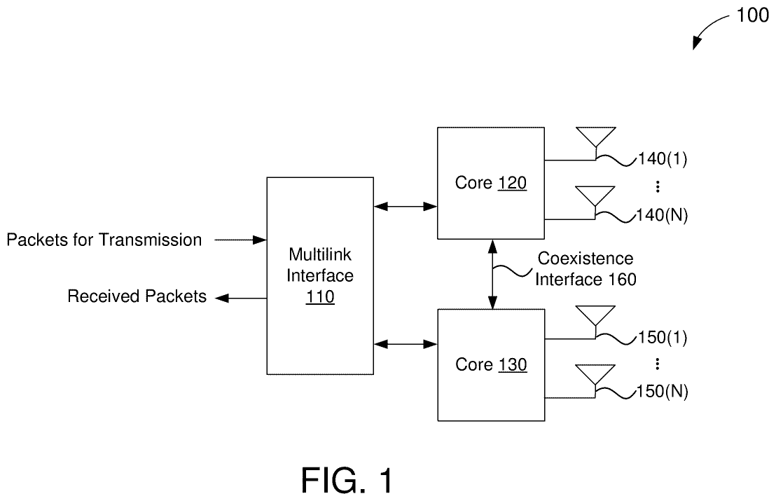

FIG. 1 shows an example system 100 for ML communication, according to some implementations. The system 100 is shown to include a multilink interface 110, a first core 120, and a second core 130. The first core 120 and the second core 130 each include a number N of antennas, 140(1) to 140(N) fore core 120 (“antennas 140”), and antennas 150(1) to 150(N) for core 130 (“antennas 150”). The first core 120 and the second core 130 are coupled via a coexistence interface 160.

The multilink interface 110 may receive packets for transmission by the system 100 and receive and reorder packets received by the first core 120 and the second core 130. The multilink interface 110 may perform operations such as frame queueing, transmission completion, receiver completion, in addition to coordinating, distributing, and consolidating commands and responses in data and management paths between a host device and the first and second cores 120 and 130. Each of the first core 120 and the second core 130 may be capable of wireless communications over a suitable frequency band, such as the 5 GHz or 6 GHz frequency bands.

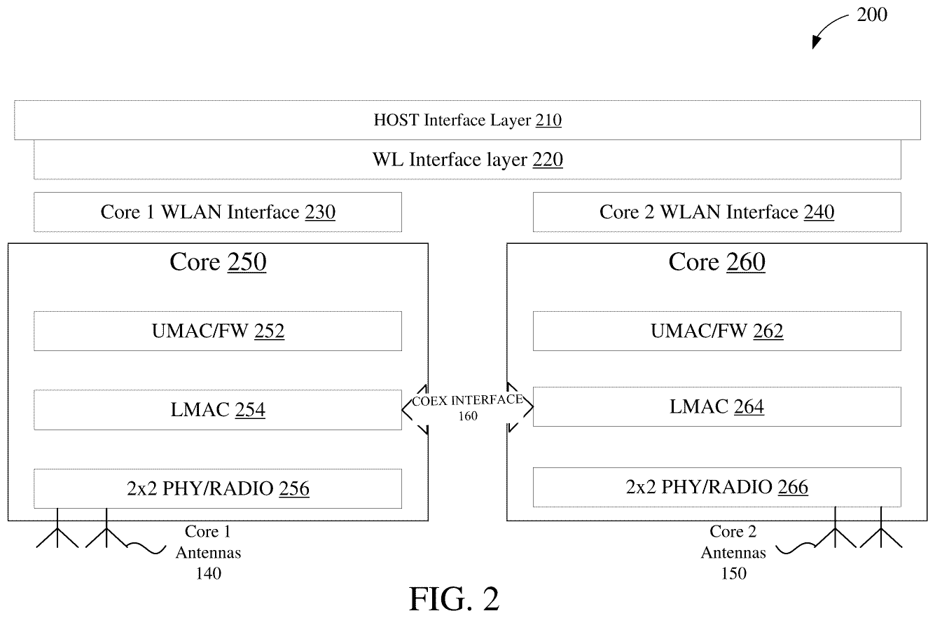

The antennas 140 and the antennas 150 may be any suitable number of antennas configured to transmit and receive signals using the core 120 and core 130, respectively. For example, the antennas 140 and the antennas 150 may each include 2 antennas, as discussed with respect to the examples of FIGS. 2-4.

The coexistence interface 160 may couple the first core 120 to the second core 130 and may be any suitable interface for information exchange. In some aspects, the coexistence interface may be a Serial Enhanced Coexistence Interface (SECI) or another suitable interface. The coexistence interface 160 may be used for exchanging information for coordinating transmission and reception of packets using the first core 120 and the second core 130 while minimizing duplicative transmissions and receptions of data, as discussed in more detail below.

FIG. 2 shows an example architecture 200 showing one implementation of the system 100, in accordance with some implementations. More particularly, the architecture 200 shows a layer level depiction of an implementation of the system 100. The architecture 200 is shown to include a host interface layer 210, a Wi-Fi or WL interface layer 220, a core 1 WLAN interface 230, a core 2 WLAN interface 240, a first core 250, a second core 260, core 1 antennas 140, and core 2 antennas 150. The first core 250 includes an upper medium access control (UMAC)/firmware (FW) layer 252, a Lower medium access control (LMAC) layer 254, and a radio 256. While in general the cores of the system 100 may each have any suitable wireless transceiver, the architecture 200 shows the core 250 to include a 2×2 physical layer and radio 256. The second core 260 is shown to include a UMAC/FW layer 262, a LMAC layer 264, and a radio 266. The first core 250 and the second core 260 are coupled via a coexistence interface 160.

The host interface layer 210 may be responsible for frame queueing, transmission and reception completion, and so on. The WL interface layer 220 may be responsible for coordinating, distributing, and consolidating commands and responses in the data and management path between the host interface layer 210 and the core 1 WLAN interface 230 and core 2 WLAN interface 240. The core 250 and core 260 may operate in any suitable frequency band, such as the 5 GHz or 6 GHZ frequency bands. Each of the core 250 and the core 260 may operate independently, having an independent WLAN interface layer and a WLAN core.

Transmitting packets using the architecture 200 may include the host interface layer 210 queueing packets to the WL interface layer 220. The WL interface layer 220 may then queue the packets to the first core 250 and the second core 260 in at least two different configurations, a first configuration where the packets queued for transmission by the first core 250 are distinct from the packets queued for transmission by the second core 260, and a second configuration where packets queued for transmission by the first core 250 are duplicated in the packets queued for transmission by the second core 260. When the packets queued for transmission by each core are distinct from each other, then each core may be free to attempt transmissions without the need for coordination between the cores. However, when packets are duplicated in the queues for the first core 250 and the second core 260, then each core is configured to attempt to avoid attempts to transmit packets which have already been transmitted by the other core. If both the first core 250 and the second core 260 each transmit the same packet, then the receiver would receive multiple copies of the same packet, which would be wasteful. Aspects of the present disclosure include techniques for avoiding such wastefully duplicative transmissions.

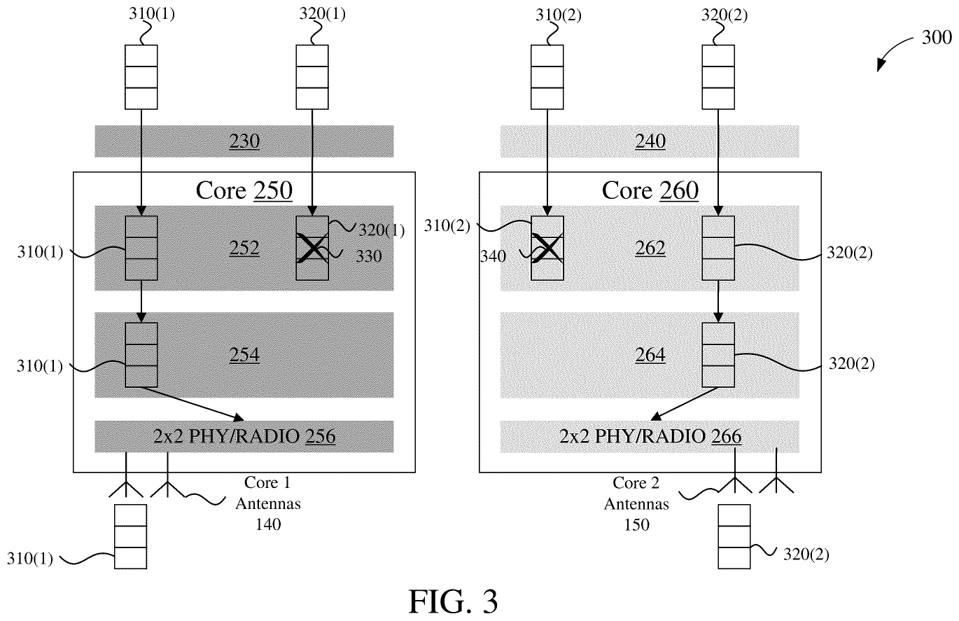

In some aspects, one or more queues of packets queued for transmission by the first core 250 may also be queued for transmission by the second core 260. However, in some cases a particular stream or traffic id (TID) is required to be transmitted by only one core. For example, an EHT ML connection may link TIDs to a particular transmitter. The example implementations may achieve similar results through queue masking. For example FIG. 3 shows an example queue flow 300 using the architecture 200 of FIG. 2, in accordance with some implementations. FIG. 3 shows a first queue of packets 310 which has a first copy 310(1) which is queued for transmission by the first core 250 and a second copy 310(2) queued for transmission by the second core 260. Similarly, a second queue of packets 320 has a first copy 320(1) queued for transmission by the first core 250 and a second copy 320(2) queued for transmission by the second core 260.

While both queues of packets, that is the first queue 310 and the second queue 320, are queued for transmission at each core, each queue may have a preferred core for transmission. For example, the first queue 310 may have the first core 250 as its preferred core, while the second queue 320 has the second core 260 as its preferred core. In some aspects, the core which is not preferred may apply a queue mask at the firmware level to mask visibility of the queue at the non-preferred core. More particularly, a WLAN interface, such as the WL interface layer 220, the core 1 WLAN interface 230 or the core 2 WLAN interface 240, may recommend a queue mask for the core which is not the preferred core. Subsequently, the UMAC/FW layer 252 for the first core 250 or the UMAC/FW layer 262 for the second core 260 may apply the queue mask so that the queues having core 250 as their preferred core are not visible at the firmware layer of the core 260 and vice versa. In the example of FIG. 3, the first copy of the first queue 310(1) is not masked by the first core 250, and passes through the UMAC/FW layer 252 unmasked. In contrast, the second copy of the first queue 310(2) is masked (340) by the second core 260, and is not visible at the UMAC/FW layer 262 of the second core. Consequently, the first queue 310 is only processed for transmission by the first core 250, shown in FIG. 3 as queue 310(1) passing through the LMAC layer 254 and being transmitted by the radio 256 via the antennas 140. Similarly, the first copy of the second queue 320(1) is masked (330) by the first core 250, and is not visible at the UMAC/FW layer 252 of the first core 250, while the second copy of the second queue 320(2) is not masked by the second core 260. Consequently, the second queue is only processed for transmission by the second core 260, shown in FIG. 3 as queue 320(2) passing through the LMAC layer 254 and being transmitted by the radio 266 via the antennas 150.

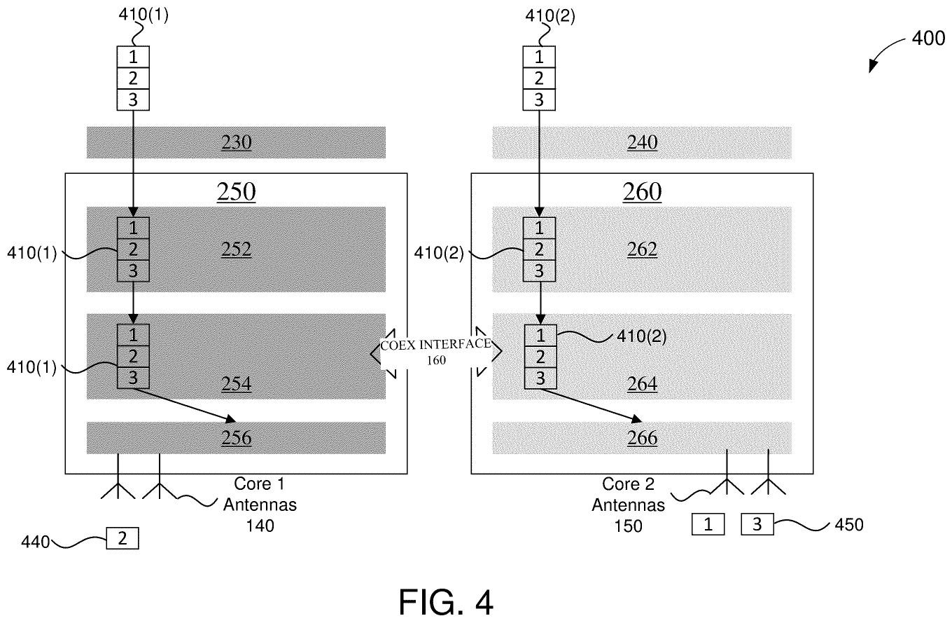

While FIG. 3 shows queues being duplicated for transmission by both cores, and a core mask being applied to limit transmission to a preferred core, in accordance with some other aspects, a common queue of packets may be provided to both cores, and each core may transmit packets from the common queue. FIG. 4 shows an example queue flow 400 using the architecture 200 of FIG. 2, in accordance with some implementations. FIG. 4 shows a simplified example where a queue 410 is provided for transmission at both the first core 250 and the second core 260, shown in FIG. 4 as a first copy of the queue 410(1) and a second copy of the queue 410(2). FIG. 4 shows the queue 410 to include three packets, numbered 1, 2, and 3, and shows the first core 250 transmitting packet 2, while the second core 260 transmits packets 1 and 3. Note that while the queue 410 is shown as including three packets, or three blocks of packets, that this is for simplicity, and the queue 410 may contain any suitable number of packets for transmission. Similarly, while FIG. 4 shows only a single queue of packets being provided for transmission by each of the cores, that this is also for simplicity, and multiple queues of packets may be provided for transmission by both of the cores, such as 4 or 8 queues of packets for example. Further, and as discussed in more detail below, the queue 410 may represent a block of packets for transmission during a specified window of time.

Because the first core 250 and the second core 260 may each transmit packets from the queue 410, coordination between the two cores is required to avoid duplicative transmissions. In some aspects, such coordination may include a combination of predetermined ground rules for transmission and information exchanged between the two cores, such as via the coexistence interface 160. Many pre-EHT devices may not be capable of the significant overhead required to share the transmission status of each packet for each queue in real time. Similarly, parsing such exchanged information in real time may not be possible for pre-EHT devices, due to the overhead and processing required. Such information exchange may delay access to the wireless medium and degrade throughput. Consequently, aspects of the present disclosure provide systematic queueing and transmission mechanisms requiring minimal exchanged information, which can be exchanged and processed in real time between the cores without undue delays in accessing the wireless medium.

In some aspects, the packets queued for transmission using both the first core 250 and the second core 260 may be queued in a block or window mode, where the queued packets are separated into blocks of packets for transmission during a predetermined window of time, such that each window begins at the same time for both cores. In some aspects, the number of packets Wq in each window may be fixed, while in some other aspects, Wq may be determined by the WL interface layer 220. In some aspects, each queue may have a common window size, while in some other aspects, the window size may vary on a per-queue basis. However, both cores maintain the same window size for their respective queues. In some aspects, each window may be identified by an integer window identifier Wq_id. All Wq packets in a window identified by Wq_id should be transmitted before the WL interface layer 220 initiates processing of the next window of packets. Such window based processing allows each core to start with a clean slate for each window, and at a specified time, simplifying coordination and synchronization of queues and transmission state at the LMAC level.

One factor which may cause degradation of performance is transmission of duplicate packets via both cores. Mitigating such degradation requires each core selecting packets for transmission which have not yet been transmitted, and which are not being currently transmitted by the other core. However, as discussed above, passing packet transmission state between the cores for each queue may require an undesirably large information exchange and amount of processing, which may not be possible for many pre-EHT or legacy devices. According to some implementations, avoiding duplicative transmission of packets may be achieved by assigning sets of packets within a window to either the first core 250 or the second core 260 in a deterministic manner. For example, one core, or link, may be assigned to be the preferred link. The preferred link is assigned to transmit one or more packets at the start of each window. Further aspects of packet assignment to each core are discussed below.

Another factor which may cause impaired performance may be one of the cores having slower transmission times, causing latency and slower throughputs. For example, the two cores may operate in two different bands, such as one core operating over a 5 GHz band and the other core operating over a 6 GHz band. The different cores may experience differing channel conditions and differing levels of network congestion, for example. The core having slower performance (the slower link) may degrade throughput and increase delays in transmitting all packets in a window. This may also cause impaired performance in the receiver receiving the transmitted packets, as delays are introduced in delivering the packets to the upper layer due to out of order reception caused by the slower performing link. In some aspects, the slower-performing link may delay a transition to a subsequent window at the firmware level, or may deprioritize the slower performing link by reducing the number of packets assigned to the slower performing link per window. Curing such impaired performance may also be accomplished by enabling the faster performing link to opportunistically transmit packets initially assigned to the slowed performing link.

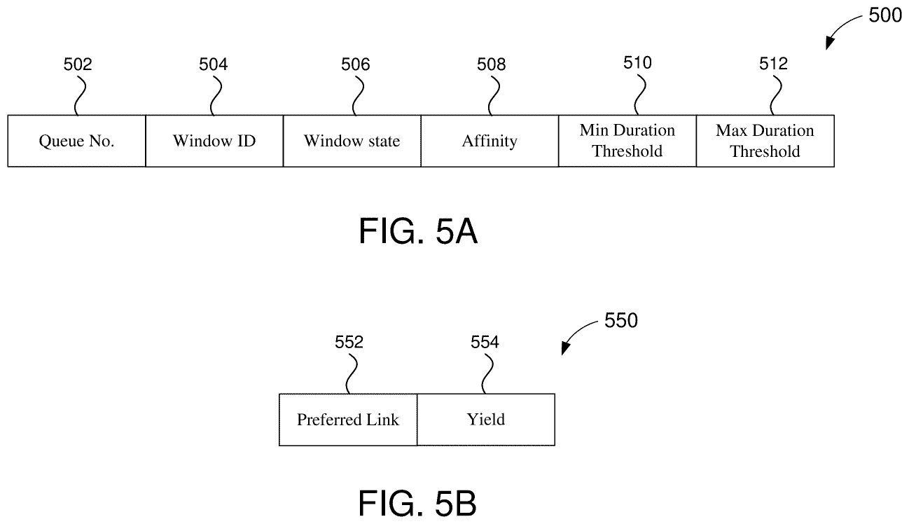

Each core, or link, may maintain a record of queue and transmission state in a predetermined format for each queue. For example, FIG. 5A shows an example data structure 500 for a queue and transmission state record, in accordance with some implementations. The data structure 500 may be used for each queue, and so for example when 8 queues are present, then each core maintains an instance of the data structure 500 including data for the first queue through the eighth queue. The data structure 500 may include a queue number field 502, indicating the queue number, such as queue 0 through queue 7 when 8 queues are present.

The data structure 500 may also include a window ID field 504 indicating the window number which is currently being processed for the queue.

The data structure 500 may also include a window state field 506, indicating the transmission state of the packets assigned to the core within the specified window ID. In some aspects, the window state may be idle, indicating that no packets remain to be transmitted in the specified window. The window state may also be locked, indicating that transmission is in progress for the window, and that the transmission duration is within the specified window duration. The window state may also be a yield state, indicating that the specified window duration has been exceeded, and that the link is starving.

The data structure 500 may also include an affinity field 508, indicating how many contiguous packets within the window are assigned for transmission by the corresponding core. In some aspects, the value of the affinity field may indicate a number of affinity units which the core is assigned to transmit during the window. For example, in some aspects the affinity unit may have a value of 8, 16, or another suitable number. For example, when a link has an affinity of 2, then the number of packets assigned to the link for transmission during a window may be (2+1) times the affinity unit. In some aspects, the affinity may be initially assigned to be equal for both cores, and may be subsequently adjusted based at least in part on throughput of packets for each core. For example, when a link has less than a threshold throughput, its affinity may be decreased, or when the link has greater than a threshold throughput its affinity may be increased.

A window may be divided between the two cores such that a first block of packets is assigned to the preferred link based on its affinity and the affinity unit, as discussed above. A second block of packets immediately following the first block of packets is assigned to the non-preferred link based on the non-preferred link's affinity and the affinity unit. In some aspects, this may continue, such that a third block of packets is assigned to the preferred link based on its affinity and the affinity unit, and then a fourth block of packets is assigned to the non-preferred link, and so on.

The data structure 500 may also include a minimum duration threshold field 510. Before the minimum duration threshold has been reached, the window state may be assigned to locked. When the minimum duration threshold has been exceeded before all assigned packets have been transmitted, then the window state may be changed to yield. In some aspects, the minimum duration threshold may be determined based at least in part on the transmission rate of the respective core. In some aspects, this minimum duration threshold may be computed and assigned by the firmware layer, such as the UMAC/FW layer 252 or 262,

The data structure 500 may also include a maximum duration threshold field 512. A link which has entered the yield state may wait this maximum duration threshold before flushing any remaining packets which it has failed to transmit from the window.

In some aspects, both the first core 250 and the second core 260 may also maintain a simplified link status field. FIG. 5B shows a data structure 550 depicting a structure for a simplified link status field, in accordance with some implementations. The data structure 550 may include a preferred link field 552 indicating whether or not the core is the preferred link. As discussed above, the first packet (along with the remaining assigned packets based on the core's affinity) of each window is assigned to the preferred link. The data structure 550 may also include a yield field 554, including a logical OR of the yield state of all queues for the core. For example, if any of the queues for a given core has a window state indicating a yield state, then the yield field 554 may be set, indicating that one or more queues for the core is in a yield state. Note that the “set” value of the yield field 554 may be a logical 1 or a logical zero, depending on configuration. The yield field 554 may enable the first core to quickly determine whether the second core is starving, and whether the first core may request the second core to transmit one or more packets initially assigned to the first core (or vice versa).

In some aspects, before initiating transmission of packets at the start of each window, each core may read data, such as the queue and transmission state data for each queue according to the data structure 500, or the link status data having the data structure 550. For example, such data may be exchanged via the coexistence interface 160. After exchanging such information, each queue may operate independently as long as the window state for the queue is locked or idle at the core.

In some aspects, the LMAC layer, such as the LMAC layer 254 or 264, determines where in its assigned packets a core transitioned to a yield state. More particularly, the LMAC may determine which queue, which block of packets and which packet within that block the core was transmitting when it transitions to the yield state, as well as the reception status of the packets of that block. As discussed above, when a queue has a window status of yield, it means that the associated core has been unable to transmit all assigned packets within a period of time specified by the minimum duration threshold, and that the other core may be able to transmit one or more packets from that queue.

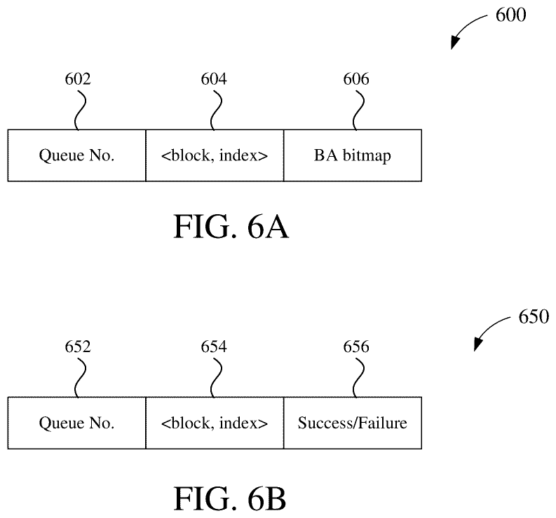

FIG. 6A shows a data structure 600 which may be one example of a data structure that the first core 250 may use for requesting that the second core 260 transmit one or more packets initially assigned to the first core 250 (or vice versa), in accordance with some implementations. Such a request may be called a “yield request” and may be sent from one core to the other via the coexistence interface 160. The data structure 600 includes a queue number field 602 indicating a queue number associated with the yield request, a block and index field 604 indicating which block of packets, and which index within that block associated with the yield request, and a BA bitmap field 606 indicating the reception status of the packets within that block.

Such a yield request may be transmitted by a core having one or more queues in a yield state. For example, if the core has been unable to transmit all of its assigned packets from a queue within the minimum duration threshold, then the core may transmit a yield request to the other core (the “yield recipient” core) proposing that the yield recipient transmit one or more of the unsent packets from the queue. In some aspects, such a yield request may only be accepted if the yield recipient is in an idle state, that is, when the yield recipient has already transmitted its assigned packets from the queue. If the yield request is accepted, for example by the yield recipient sending a message via the coexistence interface 160, then the yield recipient queues the unsent frames for transmission. After attempting to transmit the one or more frames associated with the yield request, the yield recipient may send a yield response to the core which transmitted the yield request, indicating the transmission status of the yielded one or more packets. FIG. 6B shows an example data structure 650 for a yield response, in accordance with some implementations. The data structure 650 of the yield response may include a queue number field 652 indicating the queue number associated with the yield request, a block and index field 654 indicating which block of packets, and which index within that block associated with the yield request, and a success or failure field 656 indicating success if the yield recipient has successfully transmitted the yielded packets, and failure if the yield recipient has failed to transmit the yielded packets.

If the yield recipient does not accept the yield request, or the status of the yield response is failure, and both cores enter the yield state after the maximum duration threshold has been reached, then the LMAC which sent the yield request may withdraw the request.

In addition to requiring coordination between the cores for transmission of packets, coordination may also be required for reception of packets by the first core 250 and the second core 260. For example, such coordination may be required as duplicate detection and frame reordering typically occurs at the firmware layer. In some aspects, the first core 250 and the second core 260 may exchange one or more reception status messages via the coexistence interface 160 specifying which frames were received by each core, in order to identify duplicate packets. In some aspects, the reception status messages may include a per queue reception status message and a per queue wait status message. For example, the per queue reception status message may be transmitted from the first core 250 to the second core 260 and indicate which packets the first core 250 has received from a given queue. For example, the packets may be indicated based on the queue number, and the index of the packet within the specified queue number. In addition, the per queue reception status message may indicate gaps in the indices of received packets. Duplicate packets may have two different types. A first type of duplicate packet may be received twice at the same core, and all but one of such a duplicate packet may be discarded using existing techniques. A second type of duplicate packet may be received at both the first core 250 and the second core 260, and may be identified based at least in part on the exchanged per queue reception status messages. In some aspects, when such a duplicated packet is identified, the preferred link may retain a copy of the packet, while the non-preferred link may discard the duplicate packet. After removing duplicated received packets, the first core 250 and the second core 260 may then reorder the packets and provide the reordered packets to the WL interface layer 220, and the WL interface layer 220 may consolidate the reordered packets and provide them, generating one or more receiver completion events for provision to the host.

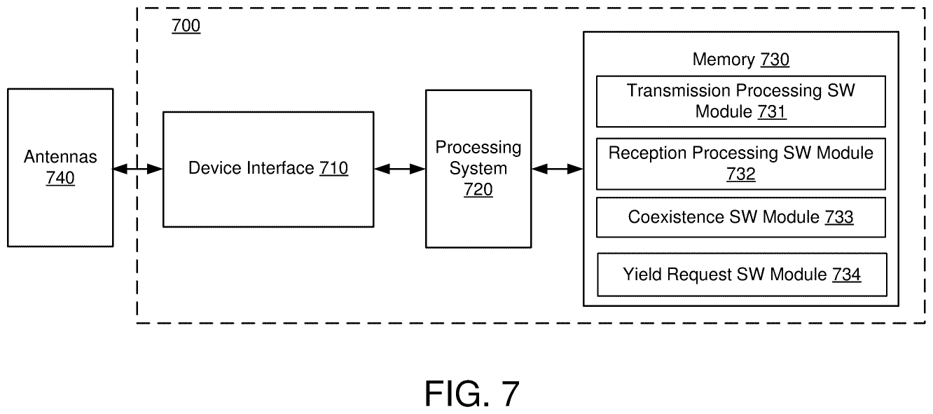

FIG. 7 shows a block diagram of an example coexistence core 700, according to some implementations. The coexistence core 700 is configured to coordinate with another core to transmit and receive packets using simplified multilink techniques, as discussed above. In some implementations, the coexistence core 700 may be one example of the first core 120, the second core 130, the first core 250, or the second core 260 described with respect to FIGS. 1-4.

The coexistence core 700 includes a device interface 710, a processing system 720, a memory 730, and includes or is coupled to two or more antennas 740. The device interface 710 is configured to communicate with one or more transmitters or receivers, to communicate with one or more host interfaces of WL interfaces, or to communicate via one or more networks.

The memory 730 may include a non-transitory computer-readable medium (including one or more nonvolatile memory elements, such as EPROM, EEPROM, Flash memory, or a hard drive, among other examples) that may store at least the following software (SW) modules:
a transmission processing SW module 731 to identify queues of packets for transmission by the coexistence core 700 using the antennas 740 based at least in part on signals exchanged with another core using the coexistence SW module 733;
a reception processing SW module 732 to process packets received by the coexistence core 700 using the antennas 740, and to reorder and remove duplicate packets based at least in part on signals exchanged with another core using the coexistence SW module 733;
a coexistence SW module 733 to exchange signals with another core coupled to the coexistence core, such as being coupled to the other core via a coexistence interface 160, where the exchanged signals coordinate the multilink transmission and reception of packets by the coexistence core 700 and the other core; and
a yield request SW module 734 to request that another core transmit one or more packets initially assigned for transmission by the coexistence core 700 based on one or more yield requests transmitted to the other core using the coexistence SW module 733, or to receive yield requests from another core using the coexistence SW module 733 and to transmit one or more packets initially assigned for transmission by the other core.

Each software module includes instructions that, when executed by the processing system 720, causes the coexistence core 700 to perform the corresponding functions.

The processing system 720 may include any suitable one or more processors capable of executing scripts or instructions of one or more software programs stored in the coexistence core 700 (such as in the memory 730). For example, the processing system 720 may execute the transmission processing SW module 731 to identify queues of packets for transmission by the coexistence core 700 using the antennas 740 based at least in part on signals exchanged with another core using the coexistence SW module 733. The processing system 720 also may execute the reception processing SW module 732 to process packets received by the coexistence core 700 using the antennas 740, and to reorder and remove duplicate packets based at least in part on signals exchanged with another core using the coexistence SW module 733. The processing system 720 may also execute the coexistence SW module 733 to exchange signals with another core coupled to the coexistence core, such as being coupled to the other core via a coexistence interface 160, where the exchanged signals coordinate the multilink transmission and reception of packets by the coexistence core 700 and the other core. The processing system 720 may also execute the yield request SW module 734 to request that another core transmit one or more packets initially assigned for transmission by the coexistence core 700 based on one or more yield requests transmitted to the other core using the coexistence SW module 733, or to receive yield requests from another core using the coexistence SW module 733 and to transmit one or more packets initially assigned for transmission by the other core.

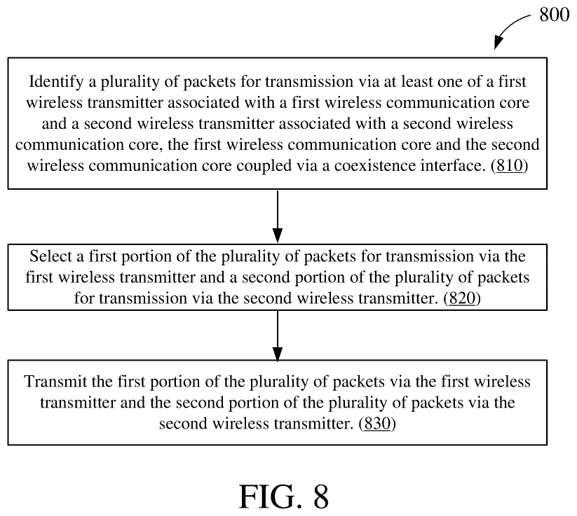

FIG. 8 shows an illustrative flowchart depicting an example operation 800 for multilink wireless communication, in accordance with some implementations. In some implementations, the example operation 800 may be performed by any suitable wireless communication system, such as one or more of the system 100 of FIG. 1, or the architecture 200 of FIG. 2, where each of the cores of the system 100 or architecture 200 may each be the coexistence core 700 of FIG. 7, may be the first core 120 and second core 130 of FIG. 1, or may be the first core 250 and the second core 260 of FIGS. 2-4.

The system 100 identifies a plurality of packets for transmission via at least one of a first wireless transmitter associated with a first wireless communication core and a second wireless transmitter associated with a second wireless core, where the first wireless communication core and the second wireless communication core are coupled via a coexistence interface (810). In some aspects, one or more of the device interface 710, the antennas 740, and the processing system 720 executing the transmission processing SW module 731 can be used to identify the plurality of packets.

The system 100 then selects a first portion of the plurality of packets for transmission via the first wireless transmitter and a second portion of the plurality of packets for transmission via the second wireless transmitter (820). In some aspects, one or more of the device interface 710, the coexistence interface 160, and the processing system 720 executing the transmission processing SW module 731, the coexistence SW module 733 and the yield request SW module 734 can be used to select the first portion and the second portion of the plurality of packets.

The system 100 then transmits the first portion of the plurality of packets via the first wireless transmitter and the second portion of the plurality of packets via the second wireless transmitter (830). In some aspects, one or more of the device interface 710, the antennas 740, and the processing system 720 executing the transmission processing SW module 731 can be used to transmit the first portion and the second portion of the plurality of packets.

In some aspects, the first portion of the plurality of packets includes one or more first queues of packets and the second portion of the plurality of packets includes one or more second queues of packets. In some aspects, at least one common queue of the one or more first queues of packets is duplicated within the one or more second queues of packets. In some aspects, selecting the second portion of the plurality of packets for transmission via the second wireless transmitter includes masking visibility of the at least one common queue from a firmware layer of the second wireless communication core, wherein masking visibility of the at least one common queue prevents transmission of the at least one common queue from the second wireless communication core.

In some aspects, the plurality of packets comprises a shared queue of packets for transmission during a specified window of time via either the first wireless transmitter or the second wireless transmitter. In some aspects, selecting the first portion and the second portion further includes selecting a first block of one or more packets of the shared queue for transmission via the first wireless transmitter and selecting a second block of one or more packets of the shared queue for transmission via the second wireless transmitter. In some aspects, the operation 800 further includes designating the first wireless transmitter as a preferred link, wherein the first block includes an initial packet of the shared queue of packets, and the second block immediately proceeds the first block of packets. In some aspects, a number of packets in the first block of packets is selected based at least in part on a first affinity associated with the first wireless transmitter, the first affinity indicating a number of contiguous packets in the shared queue of packets the first wireless transmitter is to transmit during the specified window of time. In some aspects, a number of packets in the second block is selected based at least in part on a second affinity associated with the second wireless transmitter, the second affinity indicating a number of contiguous packets in the shared queue of packets the second wireless transmitter is to transmit during the specified window of time.

In some aspects, the operation 800 further includes the first wireless transmitter determining, via the coexistence interface, a window transmission state associated with the first block of packets. In some aspects, the window transmission state associated with the first block of packets indicates that the first wireless transmitter cannot transmit one or more remaining packets of the first block of packets within the specified window of time. In some aspects, the operation 800 further includes transmitting, via the coexistence interface, a yield request requesting that the second wireless communication core complete transmission of the one or more remaining packets of the first block of packets. In some aspects, the operation further includes receiving, at the first wireless communication core a yield response responding to the yield request, the yield response indicating a transmission status associated with the one or more remaining packets.

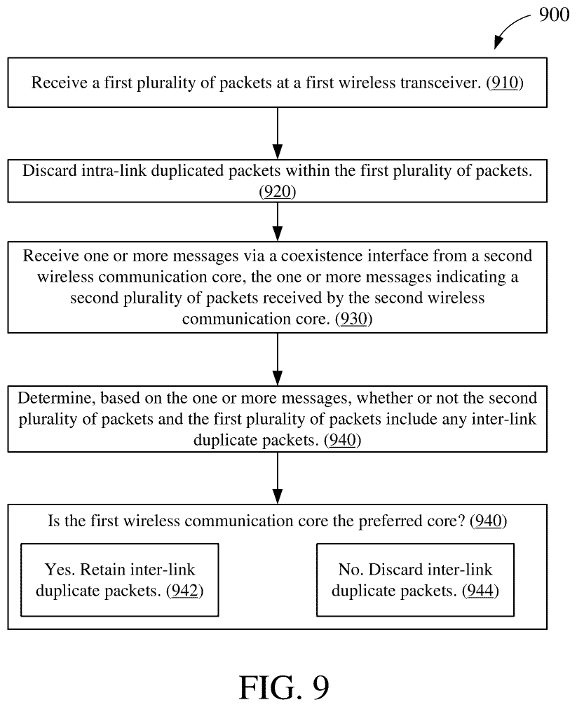

FIG. 9 shows an illustrative flowchart depicting an example operation 900 for multilink wireless communication, in accordance with some implementations. In some implementations, the example operation 900 may be performed by any suitable wireless communication core, such as the coexistence core 700 of FIG. 7, the first core 120 or the second core 130 of FIG. 1, or the first core 250 or the second core 260 of FIGS. 2-4.

The coexistence core 700 receives a first plurality of packets at a first transmitter associated with a first wireless communication core (910) In some aspects, one or more of the device interface 710, the antennas 740, and the processing system 720 executing the reception processing SW module 732 can be used to receive the first plurality of packets.

The coexistence core 700 then discards one or more intra-link duplicated packets within the first plurality of packets (920). In some aspects, the processing system 720 executing the reception processing SW module 732 can be used to discard the one or more intra-link duplicated packets.

The coexistence core 700 then receives one or more messages via a coexistence interface from a second wireless communication core, the one or more messages indicating a second plurality of packets received by the second wireless communication core (930). In some aspects, one or more of the device interface 710, the coexistence interface 160, and the processing system 720 executing the coexistence SW module 733 can be used to receive the one or more messages via the coexistence interface.

The coexistence core 700 then determines, based at least in part on the one or more messages, whether or not the second plurality of packets and the first plurality of packets include any inter-link duplicate packets (940). In some aspects, the processing system 720 executing the coexistence SW module 733 can be used to determine whether or not any inter-link duplicate packets are within the first plurality of packets and the second plurality of packets.

The coexistence core 700 then determines whether or not the first wireless communication core is the preferred core (950). If the first wireless communication core is the preferred core, then the inter-link duplicate packets are retained (942), and if the first wireless communication core is not the preferred core, the inter-link duplicate packets are discarded (944). In some aspects, the processing system 720 executing the coexistence SW module 733 may determine whether or not the first wireless communication core is the preferred core and selectively discard any inter-link duplicate packets.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for multilink wireless communication, the method performed by a wireless communication system including a first wireless communication core and a second wireless communication core, the method comprising:
identifying a plurality of packets for transmission via at least one of a first wireless transmitter associated with the first wireless communication core and a second wireless transmitter associated with the second wireless communication core, the first wireless communication core and the second wireless communication core coupled via a coexistence interface;
selecting a first portion of the plurality of packets for transmission via the first wireless transmitter and a second portion of the plurality of packets for transmission via the second wireless transmitter; and
transmitting the first portion of the plurality of packets via the first wireless transmitter and the second portion of the plurality of packets via the second wireless transmitter.

2. The method of claim 1, wherein the first portion of the plurality of packets comprises one or more first queues of packets and the second portion of the plurality of packets comprises one or more second queues of packets.

3. The method of claim 2, wherein at least one common queue of the one or more first queues of packets is duplicated within the one or more second queues of packets.

4. The method of claim 3, wherein selecting the second portion of the plurality of packets for transmission via the second wireless transmitter further comprises masking visibility of the at least one common queue from a firmware layer of the second wireless communication core, wherein masking visibility of the at least one common queue prevents transmission of the at least one common queue from the second wireless communication core.

5. The method of claim 1, wherein the plurality of packets comprises a shared queue of packets for transmission during a specified window of time via either the first wireless transmitter or the second wireless transmitter.

6. The method of claim 5, wherein selecting the first portion and the second portion further comprises selecting a first block of one or more packets of the shared queue for transmission via the first wireless transmitter and a second block of one or more packets of the shared queue for transmission via the second wireless transmitter.

7. The method of claim 6, further comprising designating the first wireless transmitter as a preferred link, wherein the first block includes an initial packet of the shared queue of packets and the second block immediately proceeds the first block of packets.

8. The method of claim 7, wherein a number of packets in the first block is selected based at least in part on a first affinity associated with the first wireless transmitter, the first affinity indicating a number of contiguous packets in the shared queue of packets the first wireless transmitter is to transmit during the specified window of time.

9. The method of claim 8, wherein a number of packets in the second block is selected based at least in part on a second affinity associated with the second wireless transmitter, the second affinity indicating a number of contiguous packets in the shared queue of packets the second wireless transmitter is to transmit during the specified window of time.

10. The method of claim 6, further comprising the first wireless communication core determining, via the coexistence interface, a window transmission state associated with the first block of one or more packets.

11. The method of claim 10, wherein the window transmission state associated with the first block of one or more packets indicates that the first wireless transmitter cannot complete transmission of one or more remaining packets in the first block of packets within the specified window of time.

12. The method of claim 11, further comprising, transmitting a yield request to the second wireless communication core via the coexistence interface, the yield request requesting that the second wireless communication core transmit the one or more remaining packets in the first block of packets.

13. The method of claim 12, further comprising, in response to transmitting the yield request to the second wireless communication core, receiving a yield response from the second wireless communication core, the yield response indicating a transmission status associated with the one or more remaining packets in the first block of packets.

14. A system for multilink wireless communication, comprising:
a first wireless communication core comprising a first wireless transmitter;
a second wireless communication core comprising a second wireless transmitter; and
a coexistence interface coupling the first wireless communication core with the second wireless communication core;
wherein the system is configured to:
identify a plurality of packets for transmission via at least one of the first wireless transmitter and the second wireless transmitter;
select a first portion of the plurality of packets for transmission via the first wireless transmitter and a second portion of the plurality of packets for transmission via the second wireless transmitter; and
transmit the first portion of the plurality of packets via the first wireless transmitter and the second portion of the plurality of packets via the second wireless transmitter.

15. The system of claim 14, wherein the first portion of the plurality of packets comprises one or more first queues of packets and the second portion of the plurality of packets comprises one or more second queues of packets.

16. The system of claim 15, wherein at least one common queue of the one or more first queues of packets is duplicated within the one or more second queues of packets.

17. The system of claim 16, wherein the system is further configured to select the second portion of the plurality of packets for transmission via the second wireless transmitter by masking visibility of the at least one common queue from a firmware layer of the second wireless communication core, wherein masking visibility of the at least one common queue prevents transmission of the at least one common queue from the second wireless communication core.

18. The system of claim 14, wherein the plurality of packets comprises a shared queue of packets for transmission during a specified window of time via either the first wireless transmitter or the second wireless transmitter.

19. The system of claim 18, wherein the system is further configured to select the first portion and the second portion further by selecting a first block of one or more packets of the shared queue for transmission via the first wireless transmitter and a second block of one or more packets of the shared queue for transmission via the second wireless transmitter.

20. A non-transitory computer-readable storage medium storing instructions for execution by one or more processors of a system for multilink wireless communication, wherein execution of the instructions causes the system to perform operations comprising:
identifying a plurality of packets for transmission via at least one of a first wireless transmitter associated with the first wireless communication core and a second wireless transmitter associated with the second wireless communication core, the first wireless communication core and the second wireless communication core coupled via a coexistence interface;
selecting a first portion of the plurality of packets for transmission via the first wireless transmitter and a second portion of the plurality of packets for transmission via the second wireless transmitter; and
transmitting the first portion of the plurality of packets via the first wireless transmitter and the second portion of the plurality of packets via the second wireless transmitter.
